(19) United States
(12) Patent Application Publication
(10) Pub. No.: US 2025/0346100 A1
(43) Pub. Date: Nov. 13, 2025

(54) ACCESSORY CONFIGURED TO INTERFACE WITH RAIL OF MOTOR VEHICLE

(71) Applicant: Ford Global Technologies, LLC, Dearborn, MI (US)

(72) Inventors: Daniel Trentin, Ivanhoe (AU); David Andrew Spink, Jan Juc (AU); Peter J. Caddy, LARA (AU)

(21) Appl. No.: 18/661,784

(22) Filed: May 13, 2024

(51) Int. Cl. B60J 7/04; B60J 7/19

(52) U.S. Cl. CPC B60J 7/041; B60J 7/198

(57) ABSTRACT

This disclosure relates to an accessory configured to interface with a rail, such as a bedside rail, of a motor vehicle. In some aspects, the techniques described herein relate to an assembly, including: a rail including a slot, wherein the slot leads to a cavity; and an accessory including a fixture portion and a clamp portion, wherein the accessory is configurable between a locked position and an unlocked position, wherein, in the unlocked position, the clamp portion of the accessory is insertable into and removable from the cavity via the slot, and wherein, when the clamp portion is within the cavity and the accessory is in the locked position, the clamp portion is not removable from the cavity via the slot.

### TECHNICAL FIELD

This disclosure relates to an accessory configured to interface with a rail, such as a bedside rail, of a motor vehicle.

### BACKGROUND

Pickup trucks typically include an enclosed cab and a cargo area (sometimes referred to as a cargo box, cargo bed, truck bed, or generally a “bed”) having a bottom wall (sometimes called a floor or bed), side walls extending along opposite sides of the cargo area, and a tailgate. The tailgate typically swings relative to the side walls between an upright, closed position and a horizontal, open position.

### SUMMARY

In some aspects, the techniques described herein relate to an assembly, including: a rail including a slot, wherein the slot leads to a cavity; and an accessory including a fixture portion and a clamp portion, wherein the accessory is configurable between a locked position and an unlocked position, wherein, in the unlocked position, the clamp portion of the accessory is insertable into and removable from the cavity via the slot, and wherein, when the clamp portion is within the cavity and the accessory is in the locked position, the clamp portion is not removable from the cavity via the slot.

In some aspects, the techniques described herein relate to an assembly, wherein the accessory is configurable between the locked and unlocked positions by rotation of the fixture.

In some aspects, the techniques described herein relate to an assembly, wherein: the clamp portion includes a cam, and the cam is configured to rotate with the fixture.

In some aspects, the techniques described herein relate to an assembly, wherein: the accessory further includes a housing, the housing includes a through-bore, and the cam is arranged at least partially in the through-bore.

In some aspects, the techniques described herein relate to an assembly, wherein the fixture is rotatably mounted to the housing.

In some aspects, the techniques described herein relate to an assembly, wherein: a pin projects from an opposite side of the housing as the fixture, the rail includes at least one hole on an opposite side of the rail as the slot, the pin is configured to project into the at least one hole.

In some aspects, the techniques described herein relate to an assembly, wherein: the cam includes a first dimension and a second dimension greater than the first dimension, when the accessory is in the unlocked position, the first dimension is oriented substantially parallel to a central axis of the through-bore; when the accessory is in the locked position, the second dimension is oriented substantially parallel to the central axis of the through-bore.

In some aspects, the techniques described herein relate to an assembly, wherein: the rail includes a first surface defining the cavity, the rail includes a second surface defining the cavity on an opposite side of the cavity as the first surface, and when the accessory is in the locked position, the clamp portion of the accessory is configured to directly contact the first and second surfaces of the rail.

In some aspects, the techniques described herein relate to an assembly, wherein, when the accessory is in the locked position, the cam is configured to directly contact the first and second surfaces of the rail.

In some aspects, the techniques described herein relate to an assembly, wherein: the clamp portion includes a first slider and a second slider moveable within the through-bore in response to movement of the cam, and when the accessory is in the locked position, the cam is positioned such that the first slider and the second slider are in direct contact with the first and second surfaces of the rail, respectively.

In some aspects, the techniques described herein relate to an assembly, wherein the accessory is configured to hold the fixture in the locked position.

In some aspects, the techniques described herein relate to an assembly, wherein: the accessory further includes a housing including a recess, the fixture is rotatably mounted to the housing, the recess is formed in a side of the housing facing the fixture, the accessory further includes a detent at least partially within the recess, the detent is moveable within the recess, the detent is biased toward the fixture, and the detent includes a slot configured to receive a portion of the fixture when the accessory is in the locked position.

In some aspects, the techniques described herein relate to an assembly, wherein: the detent includes a first ramped wall leading to an opening of the slot, the detent includes a second ramped wall leading to an opening of the slot, and the first and second ramped walls are inclined such that the first and second ramped walls become gradually closer to the housing when moving away from the slot.

In some aspects, the techniques described herein relate to an assembly, wherein: the accessory further includes a fastener, the accessory further includes a housing, the fixture and the fastener are rotatably mounted to the housing, the fixture is attached to a plate including a notch, the fastener is biased toward the plate and the notch, a portion of the fastener is configured to be received in the notch when the accessory is in the locked position.

In some aspects, the techniques described herein relate to an assembly, wherein the portion of the fastener is configured to abut the plate when the accessory is in the unlocked position.

In some aspects, the techniques described herein relate to an assembly, wherein the fixture is one of a tie-down, a cleat, a handle, and a portion of a cross-bar.

In some aspects, the techniques described herein relate to an assembly, wherein the fixture includes a portion defining a closed-loop.

In some aspects, the techniques described herein relate to an assembly, wherein the rail extends along a side wall of a cargo area of a motor vehicle.

In some aspects, the techniques described herein relate to a method, including: inserting an accessory into a slot of a rail such that a clamp portion of the accessory is within a cavity of the rail when the accessory is in an unlocked position; and following the inserting step, configuring the accessory in a locked position in which the clamp portion is not removable from the cavity via the slot.

In some aspects, the techniques described herein relate to a method, further including: following the step of configuring the accessory in the locked position, configuring the accessory in the unlocked position and removing the clamp portion from the cavity via the slot.

### BRIEF DESCRIPTION OF THE DRAWINGS

FIG. 1 is a rear perspective view of a portion of a motor vehicle.

FIG. 2 is a close-up view of a rail of the motor vehicle and three example accessories mounted to the rail.

FIG. 3 is a view similar to FIG. 2 with a single example accessory mounted to the rail.

FIG. 4 is a cross-sectional view of the rail.

FIG. 5 is a view of a first example accessory relative to the rail. In FIG. 5, the first example accessory is in an unlocked position.

FIG. 6 is a view of a first example accessory relative to the rail. In FIG. 6, the first example accessory is in a locked position.

FIG. 7 is a cross-sectional view of the first example accessory in the unlocked position.

FIG. 8 is a cross-sectional view of the first example accessory in the locked position.

FIG. 9 is another view of the first example accessory relative to the rail. In FIG. 9, the first example accessory is in the unlocked position. FIG. 9 is representative of a position and configuration of the first example accessory as the first example accessory is being inserted into or removed from a slot of the rail.

FIG. 10 is another view of the first example accessory relative to the rail. In FIG. 10, the first example accessory is in the unlocked position and a clamp portion of the first example accessory is within the rail.

FIG. 11 is another view of the first example accessory relative to the rail. In FIG. 11, the first example accessory is in the locked position and the clamp portion of the first example accessory is within the rail.

FIG. 12 is a view of a second example accessory relative to the rail. In FIG. 12, the second example accessory is in an unlocked position.

FIG. 13 is a view of the second example accessory relative to the rail. In FIG. 13, the second example accessory is in a locked position.

FIG. 14 is a cross-sectional view of the second example accessory in the unlocked position.

FIG. 15 is a cross-sectional view of the second example accessory in the locked position.

FIG. 16 is a cross-sectional view of a clamp portion of the second example accessory in the unlocked position.

FIG. 17 is a cross-sectional view of the clamp portion of the second example accessory in the locked position.

### DETAILED DESCRIPTION

This disclosure relates to an accessory configured to interface with a rail, such as a bedside rail, of a motor vehicle. In an example, the accessory includes a fixture portion and a clamp portion. The accessory is configured to selectively be clamped to and released from a rail of a motor vehicle. The rail may be adjacent a cargo area of the motor vehicle. When the accessory is in a locked position and clamped to the rail, a fixture of the accessory can be used as a hand hold or a mounting point for gear. In this regard, the fixture may be configured as a tie-down, cleat, or a cross-bar. The accessory of this disclosure provides a user with increased usability and customization of their vehicle. Further, the accessory of this disclosure can interface with one or more types of rails and/or rails of differing geometries. These and other benefits will be appreciated from the following description.

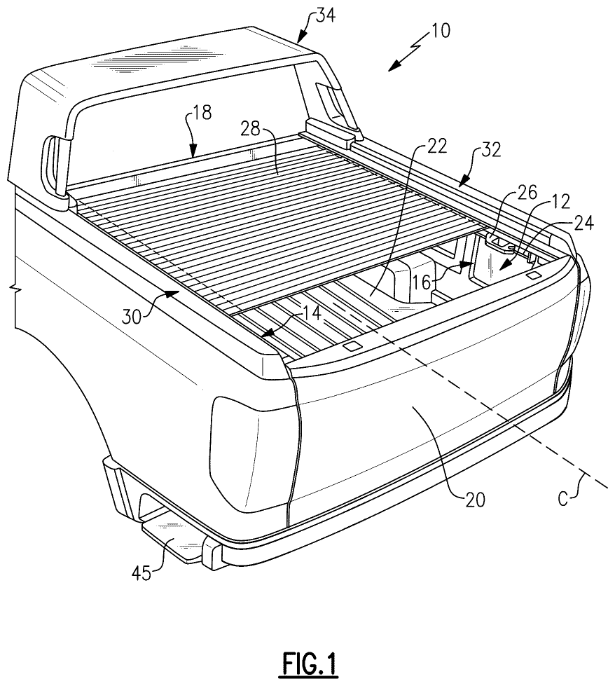

FIG. 1 illustrates a portion of a motor vehicle 10 (“vehicle 10”) from a rear perspective. In FIG. 1, the vehicle 10 is a pickup truck. This disclosure extends to vehicles that are not pickup trucks, however, and includes vehicle types such as vans, sport utility vehicles (SUVs), sedans, etc.

The vehicle 10 includes a cargo area 12 defined by a first side wall 14 and a second side wall 16 on an opposite side of the cargo area 12 as the first side wall 14. A front bed wall 18 extends between the first side wall 14 and the second side wall 16 to enclose a front end of the cargo area 12. A tailgate 20 is positioned at a rear of the vehicle 10 and is moveable between an open position and a closed position. FIG. 1 shows the tailgate 20 in the closed position. A bottom wall 22, sometimes called a bed, defines a bottom of the cargo area 12. A passenger cabin (not shown) is at a front of the vehicle 10.

The first and second side walls 14, 16 extend in a direction substantially parallel to a length of the vehicle 10 and parallel to a centerline C of the vehicle 10. The cargo area 12 is substantially symmetrical about the centerline C.

The cargo area 12, in this example, is equipped with a plurality of rails. As shown in FIG. 1, the second side wall 16 includes a rail 24. The first side wall 14 includes a similar rail (not shown) vertically aligned, relative to the bottom wall 22, with the rail 24. The rail 24 extends substantially parallel to the centerline C. One or more cleats or tie-downs are configured to be attached to the rail 24. An example tie-down 26 is shown in FIG. 1.

The cargo area 12 further includes a tonneau cover 28. The tonneau cover 28 is moveable along a length of the vehicle 10 between a deployed position, in which the tonneau cover 28 substantially fully overlaps the bottom wall 22, and a retracted position, in which the tonneau cover 28 does not overlap the bottom wall 22. The tonneau cover 28 is also moveable to a number of intermediate positions between the retracted and deployed positions. In FIG. 1, the tonneau cover 28 is in an intermediate position in which the tonneau cover 28 partially overlaps the bottom wall 22. The rail 24, and the corresponding rail on the first side wall 14, is vertically beneath the tonneau cover 28 in this example. A tonneau cover is not required in all examples.

The cargo area 12 further includes another set of rails, in this example, namely a first rail 30 and a second rail 32 mounted adjacent a top of a respective one of the first and second side walls 14, 16. The first and second rails 30, 32 are vertically aligned with one another relative to the bottom wall 22, and project vertically above the tonneau cover 28, in this example. The first and second rails 30, 32 may be referred to as upper rails, while the rail 24 and the corresponding rail of the first side wall 14 may be referred to as lower rails. While the cargo area 12 includes two sets of rails, namely a set of lower rails and a set of upper rails, this disclosure extends to cargo areas 12 that include one or more sets of rails. Each of the rails within the two sets of rails may be referred to as a bedside rail. While bedside rails are mentioned, this disclosure applies to rails mounted relative to other spaces of a motor vehicle that are not beds.

In one example, the cargo area 12 further includes a rear support subsystem, or simply a rear support, 34 which is supported for movement along the first and second rails 30, 32 and facilitates carrying various items above the bottom wall 22. The rear support subsystem 34 is not required in all examples of this disclosure.

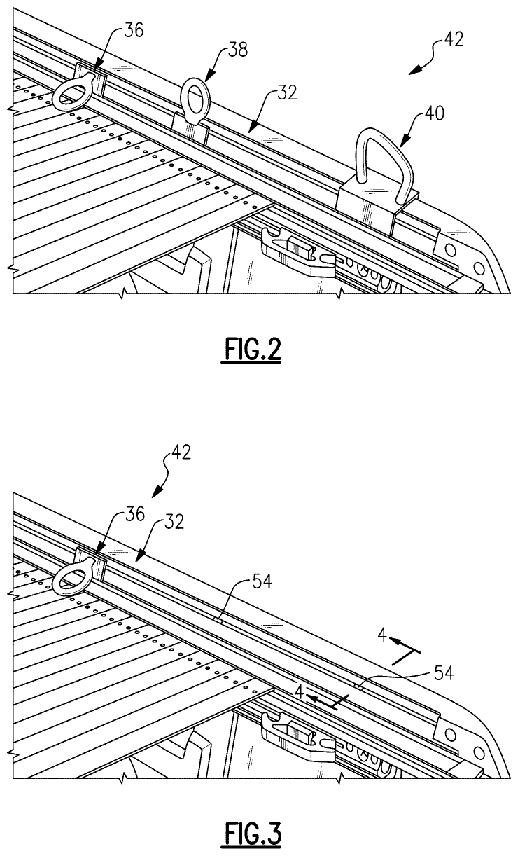

In this disclosure, one or more accessories are configured for use with one of the first and second rails 30, 32. With reference to FIG. 2, a first accessory 36, a second accessory 38, and a third accessory 40 are attached to the second rail 32. Together, the second rail 32 and the accessories 36, 38, 40 provide an assembly 42. While three accessories 36, 38, 40 are shown relative to the second rail 32 in FIG. 2, this disclosure extends to assemblies with one or more accessories.

In FIG. 2, the three accessories 36, 38, 40 are spaced-apart from one another along the length of the second rail 32. Further, the accessories 36, 38, 40 provide different functionalities. In the example of FIG. 2, the first accessory 36 includes a fixture which is configured as a loop oriented substantially parallel to the bottom wall 22. The first accessory 36 may be referred to as a horizontal tie-down. The second accessory 38 includes a fixture which is configured as a loop oriented substantially perpendicular to the bottom wall 22 and may be referred to as a vertical tie-down. The first and second accessories 36, 38 may provide attachment points for gear or straps, as examples. The third accessory 40 is configured as a hand hold. The third accessory 40 may be grasped by a user as the user is attempting to enter or exit the cargo area 12, such as when the user steps onto the tailgate 20 (when the tailgate 20 is in an open position, for example) and/or when a user steps onto a side step 45 (FIG. 1) adjacent a rear of the vehicle 10. While various example accessories have been shown in FIG. 2, this disclosure extends to accessories providing additional functionality.

In FIG. 3, the assembly 42 includes the second rail 32 and the first accessory 36. Additional detail of the assembly 42 of FIG. 3 will now be shown and described. While this additional detail is shown relative to the first accessory 36 and the second rail 32, the first rail 30 is configured substantially similar to the second rail 32, reflected about the centerline C, and is configured to interface with one or more accessories configured substantially as one of the accessories 36, 38, 40.

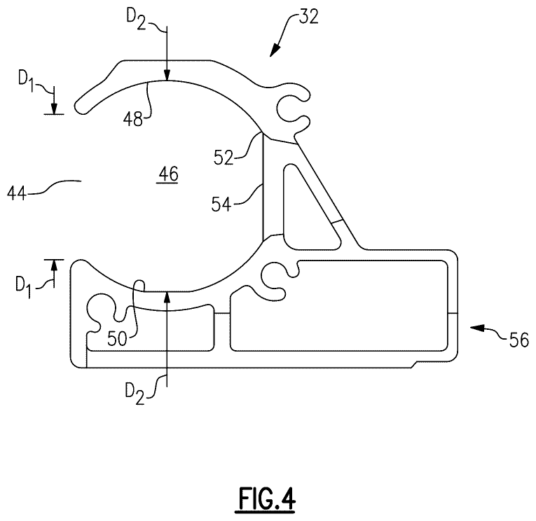

FIG. 4 is a cross-sectional view of the second rail 32 taken along line 4-4 in FIG. 3. With reference to FIG. 4, the second rail 32 includes a slot 44 leading to a cavity 46. The slot 44 is an opening in a side of the second rail 32 facing the centerline C. The slot 44 and cavity 46 extend along an entire longitudinal length of the second rail 32. The second rail 32 substantially resembles a reverse “C-shape” in this example. A vertical dimension D1 of the slot 44 is less than a vertical dimension D2 of the cavity 46. The second rail 32 includes an upper surface 48 and a lower surface 50 on a generally opposite side of the cavity 46 as the upper surface 48. The upper and lower surfaces 48, 50 are spaced-apart by a side surface 52. The side surface 52 is on a generally opposite side of the cavity 46 as the slot 44. The upper, lower, and side surfaces 48, 50, 52 each define a portion of the cavity 46.

The side surface 52 includes a hole 54. The hole 54 may be a through-bore or recess. As shown in FIG. 3, a plurality of holes 54 may be arranged in the second rail 32, with the holes spaced-apart from one another along the length of the second rail 32. As will be discussed below, the holes 54 may facilitate attachment of an accessory to the second rail 32. The holes 54 are not required in all examples.

The second rail 32 includes a mounting section 56 supporting the various structures of the second rail 32 and configured to facilitate attaching the second rail 32 to a top of the second side wall 16.

The first accessory 36 will now be described in more detail. The first accessory 36 is configured to be partially inserted into, and removed from, the cavity 46 via the slot 44. This is particularly beneficial in configurations in which the second rail 32 does not exhibit any vertical openings, such as openings in either the first or second surfaces 48, 50, that would permit ingress or egress of the first accessory 36 relative to the cavity 46. Indeed, in one aspect of this disclosure, the second rail 32 does not exhibit any such vertical openings that would permit ingress or egress of the first accessory 36 relative to the cavity 46.

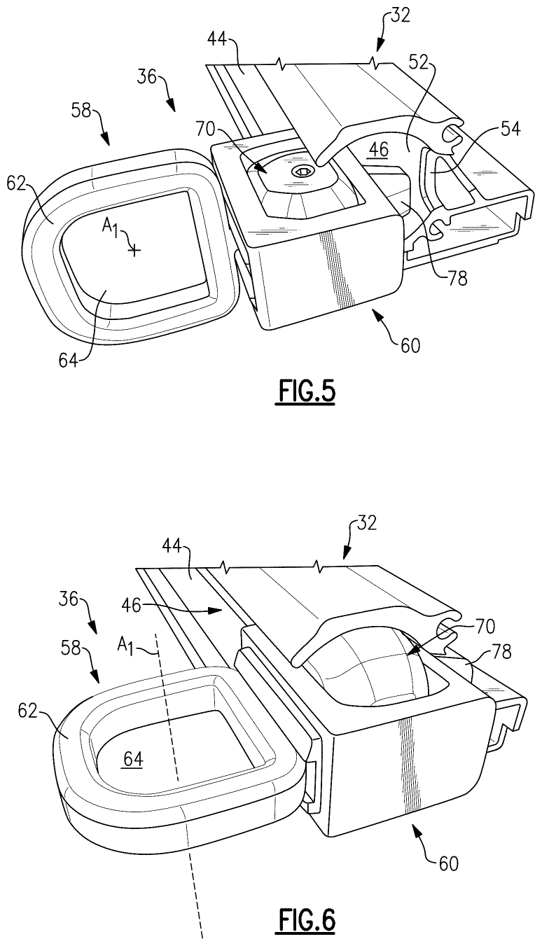

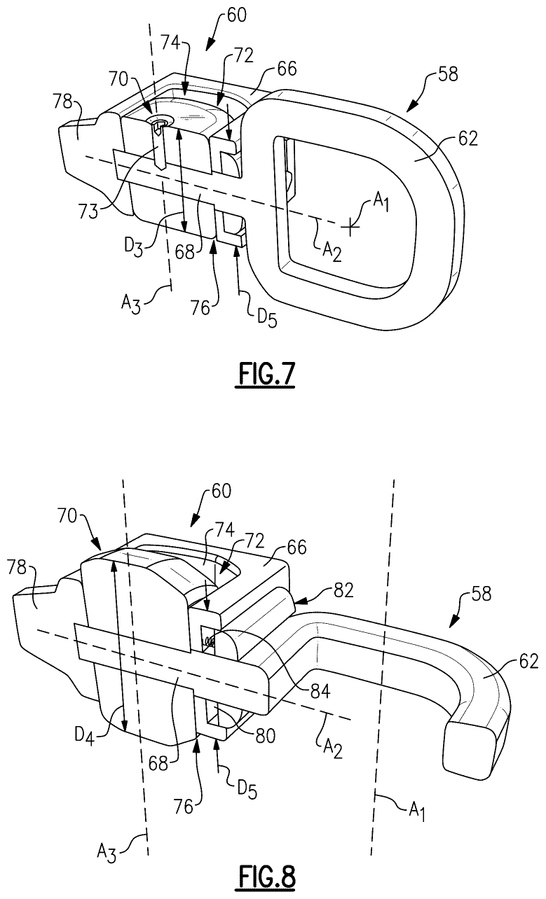

The first accessory 36 is shown in an unlocked position in FIG. 5 and a locked position in FIG. 6 relative to the second rail 32. FIGS. 7 and 8 are cross-sectional views representative of the first accessory 36 in unlocked and locked positions, respectively, relative to the second rail 32. With joint reference to FIGS. 5-8, the first accessory 36 includes a fixture portion 58 and a clamp portion 60. In the unlocked position of FIG. 5, the clamp portion 60 is insertable into and removable from the cavity 46 via the slot 44. Further, when the clamp portion 60 is within the cavity 46 and the first accessory 36 is in the locked position, as in FIG. 6, the clamp portion 60 is not removable from the cavity 46 via the slot 44. Further, in the position of FIG. 6, the fixture portion 58 is not within the slot 44 and is accessible and useable as a tie-down, in this example. In this embodiment, the fixture portion 58 is configured as a horizonal tie-down. The fixture portion 58 may be configured as a cleat or a hand hold in other examples.

In the embodiment of FIGS. 5 and 6, the fixture portion 58 includes a loop 62. The loop 62 is a closed-loop in this example. The loop 62 need not be a closed-loop in all examples.

The loop 62 encircles an opening 64 arranged about axis A1. In the locked position, the axis A1 is substantially perpendicular to a plane of the bottom wall 22. The fixture portion 58 is rotatably mounted to a housing 66 of the first accessory 36 via a shaft 68. The shaft 68 extends along axis A2, which is substantially perpendicular to the axis A1. The fixture portion 58 is rotatable relative to the housing 66 together with the shaft about axis A2. Moving the first accessory 36 between the locked and unlocked positions involves rotating the fixture portion 58 substantially 90° about axis A2 in an example.

The clamp portion 60 includes a cam 70 attached to the shaft 68 at a generally opposite side of the shaft 68 as the fixture portion 58. The cam 70 is arranged in a through-bore 72 of the housing 66. The through-bore 72 extends along an axis A3, which is the central axis of the through-bore 72, between a first opening 74 and a second opening 76 of the housing 66. The first and second openings 74, 76 lead to the through-bore 72. Axis A3 is substantially perpendicular to the axis A2.

The cam 70 is a structure exhibiting a shaped profile configured to translate rotation of the fixture portion 58 and shaft 68 about axis A2 into a vertical force being applied to the second rail 32 either directly or indirectly. In the embodiment of FIGS. 5-8, the cam 70 is configured to directly contact the second rail 32 when the clamp portion 60 is in the cavity 46 and the first accessory 36 is in the locked position.

In FIGS. 5-8, the cam 70 is attached to the shaft 68 via a set screw 73 interfaced with the cam 70 and the shaft 68, as shown in FIG. 7. In this regard, the cam 70 is a separate structure from the shaft 68. In other embodiments, the cam 70 may be integrally formed with the shaft 68. The cam 70 is configured to rotate about axis A with rotation of the fixture portion 58 and the shaft 68.

The cam 70 does not exhibit a consistent diameter about its circumference, in this example. In particular, in this example, the cam 70 is shaped substantially as an ellipsoid. The cam 70 exhibits a first dimension D3 in cross-section, measured in a direction parallel to the axis A3, in the unlocked position. When the cam 70 is in the locked position, the cam 70 exhibits a second dimension D4 greater than the first dimension D3, measured in the same manner, namely in a direction parallel to the axis A3. The cam 70 exhibits either the first dimension D3 or the second dimension D4, in an alternating arrangement, substantially every 90° about the circumference of the cam 70. The diameter of the cam 70 gradually transitions between the first and second dimensions D3, D4 moving about the circumference of the cam 70.

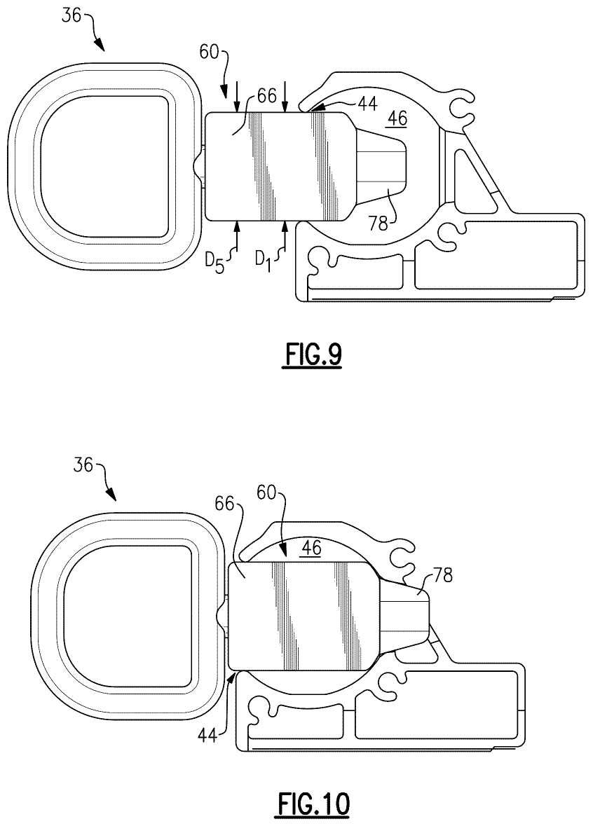

In the unlocked position, the cam 70 is oriented such that the first dimension D3 is substantially parallel to axis A3. Further, the first dimension D3 is such that the cam 70 does not project vertically above or below (i.e., relative to the axis A3) the housing 66 (i.e., vertically beyond either the first or second openings 74, 76). Further, the housing 66 exhibits a vertical dimension D5 (i.e., parallel to axis A3) less than dimension D1 such that, in the unlocked position, clamp portion 60 is insertable into the cavity 46 via the slot 44, as generally shown in FIGS. 9 and 10.

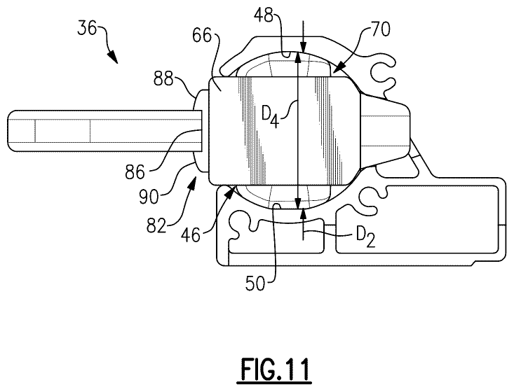

In the locked position, as shown in FIGS. 6, 8, and 11, the cam 70 is oriented such that the second dimension D4 is substantially parallel to axis A3. The second dimension D4 is sized such that, in the locked position, a portion of the cam 70 projects vertically above the housing 66, beyond first opening 74, and another portion of the cam 70 projects vertically below the housing 66, beyond second opening 76. When the clamp portion 60 is within the cavity 46 and the fixture portion 58 is rotated to the locked position, as shown in FIGS. 6 and 11, the cam 70 directly contacts the upper surface 48 and the lower surface 50 of the second rail 32 and applies force thereto. In this regard, the dimensions D2 and D4 may be substantially equal. Because the second dimension D4 is greater than the dimension D1 of the slot 44, when the first accessory 36 is in the locked position, the clamp portion 60 is not removable from the cavity 46.

In this example, the first accessory 36 further includes a pin 78. In this example, the pin 78 is integrally formed with the housing 66. The pin 78 projects from an opposite side of the housing 66 as the fixture portion 58. The pin 78 is centered around axis A2 and gradually tapers moving away from the housing 66. The pin 78 is configured to be received in the hole 54 of the side surface 52 to restrict movement of the first accessory 36 along a length of the second rail 32. The pin 78 is not required in all examples. In other examples, the forces applied to the second rail 32 via the cam 70 are sufficient to restrict movement of the first accessory 36 along the second rail 32.

In another aspect of this disclosure, the first accessory 36 is configured to hold the fixture portion 58 in the locked position. In particular, with reference to FIG. 8, the housing 66 includes a recess 80 in a side of the housing 66 facing the fixture portion 58. The accessory further comprises a detent 82 at least partially within the recess 80 and is moveable within the recess 80. The detent 82 is biased, in this example by a spring 84 within the recess 80, toward the fixture portion 58. The detent 82 includes a slot 86 (FIG. 11) configured to receive a portion of the fixture portion 58 when the first accessory 36 is in the locked position. The detent 82, in this example, further includes a first ramped wall 88 leading to an opening of the slot 86 and a second ramped wall 90 leading to the opening of the slot 86. The first and second ramped walls 88, 90 are inclined such that the first and second ramped walls 88, 90 become gradually closer, as measured in a left-to-right direction in FIG. 11, to the housing 66 when moving vertically (i.e., in the up-and-down direction in FIG. 11) away from the slot 86.

Another example assembly 142 is shown in FIG. 12. To the extent not otherwise described or shown, the assembly 142 corresponds to the assembly 42 of FIGS. 4-11 with like parts having reference numerals preappended with a “1.”

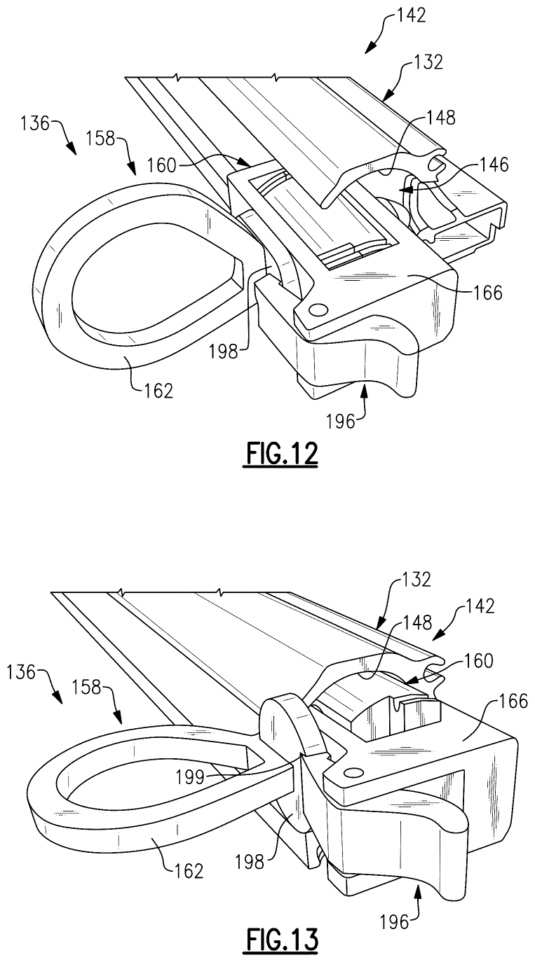

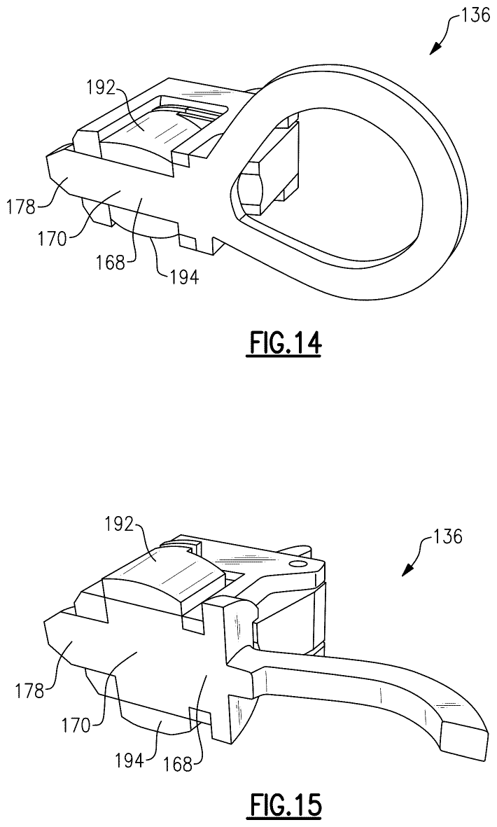

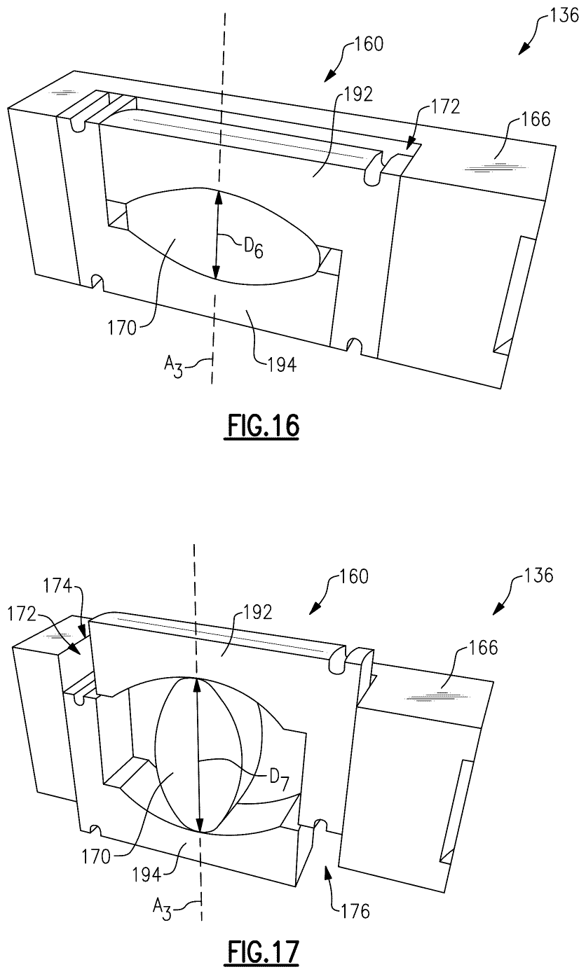

FIG. 12 shows another accessory 136 which is configured as a horizontal tie-down. In FIG. 12, the accessory 136 is in the unlocked position. FIG. 13 shows the accessory 136 in the locked position. FIGS. 14 and 15 are cross-sectional views representative of the accessory 136 in unlocked and locked positions, respectively. FIGS. 16 and 17 are cross-sectional views representative of the clamp portion 160 when the accessory 136 is in unlocked and locked positions, respectively.

As shown in FIGS. 12-17, the fixture portion 158 includes a loop 162 which is shaped substantially differently relative to the loop 62. It should be understood that this disclosure is not limited to any particular shape of the fixture portion.

Another difference between accessory 136 and first accessory 36 is that the pin 178 of accessory 136 is integrally formed with the shaft 168. As with the above embodiment, the pin 178 is not required in all examples.

The accessory 136 is also configured such that the cam 170 indirectly contacts the second rail 132 when the clamp portion 160 is within the second rail 132 and the accessory 136 is in the locked position. In this example, the clamp portion 160 includes a first slider 192 and a second slider 194 moveable within the through-bore 172 in response to movement of the cam 170.

The cam 170 is substantially ellipsoid-shaped, but is relatively smaller when compared to cam 70. The cam 170 is also formed integrally with the shaft 168, in this example. As with the cam 70, the cam 170 exhibits a first dimension D6 in cross-section, measured in a direction parallel to the axis A3, in the unlocked position. When the cam 70 is in the locked position, the cam 70 exhibits a second dimension D7 greater than the first dimension D6, measured in the same manner, namely in a direction parallel to the axis A3. The second dimension D7 is less than second dimension D4. Specifically, in the locked position, the cam 170 does not projected beyond the through-bore 172.

In the unlocked position, the cam 170 is oriented such that the first dimension D6 is substantially parallel to axis A3. In the unlocked position, the first and second sliders 192, 194 do not project vertically above or below (i.e., relative to the axis A3) the housing 166 (i.e., vertically beyond either the first or second openings 174, 176). In the locked position, as shown in FIG. 17, the cam 70 is oriented such that the second dimension D7 is substantially parallel to axis A3. In the locked position, a portion of the first slider 192 projects vertically above the housing 166, beyond first opening 174, and a portion of the second slider 194 projects vertically below the housing 166, beyond second opening 176. When the clamp portion 160 is within the cavity 146 and the fixture portion 158 is rotated to the locked position, the cam 170 causes the first and second sliders 192, 194 to contact the upper surface 148 and the lower surface (not shown in FIG. 12 or 13) of the second rail 132 and applies force thereto.

The accessory 136 is configured to hold the fixture in the locked position in a manner different than first accessory 36. With reference to FIGS. 12 and 13, the accessory 136 further comprises a fastener assembly, including an integrated bar and a lever, 196 (i.e., “fastener 196”) rotatably mounted to the housing 166. The fixture portion 158 is attached to a plate 198 including a notch 199. The fastener assembly 196 is biased, such as by a spring or otherwise, toward the plate 198 and the notch 199. Further, an end portion of the fastener assembly 196 is configured to be received in the notch 199 when the accessory 136 is in the locked position, as shown in FIG. 13. The fixture portion 158 can be rotated to the unlocked position when a force is applied to the fastener assembly 196 to remove the fastener assembly 196 from the notch 199. The end portion of the fastener assembly 196 is configured to abut the plate 198, namely a surface of the plate facing the fixture portion 158 when the accessory 136 is in the unlocked position, as shown in FIG. 12.

The details discussed above with respect to one embodiment could be applied to the other disclosed embodiment. For instance, the first accessory 36 could include a pin formed integrally with shaft 68, similar to how pin 178 is formed integrally with shaft 168 in the accessory 136. As yet another example, the shaft 68 of first accessory 36 could include an integrally-formed cam, similar to how cam 170 is integrally formed with shaft 168. As still another example, the fastener assembly of the accessory 136 could be provided in the first accessory 36, and the accessory 136 could include the detent mechanism of first accessory 36.

Directional terms such as “upward,” “upper,” “above,” “downward,” “lower,” “under,” “below,” “side,” “inside,” “outside,” “horizontal,” etc., are used herein with reference to the normal operational attitude of a motor vehicle. It should be understood that terms such as “slightly,” “minimal,” “generally,” “substantially,” and “about” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. An assembly, comprising:
a rail including a slot, wherein the slot leads to a cavity; and
an accessory including a fixture portion and a clamp portion, wherein the accessory is configurable between a locked position and an unlocked position, wherein, in the unlocked position, the clamp portion of the accessory is insertable into and removable from the cavity via the slot, and wherein, when the clamp portion is within the cavity and the accessory is in the locked position, the clamp portion is not removable from the cavity via the slot.

2. The assembly as recited in claim 1, wherein the accessory is configurable between the locked and unlocked positions by rotation of the fixture.

3. The assembly as recited in claim 2, wherein:
the clamp portion includes a cam, and
the cam is configured to rotate with the fixture.

4. The assembly as recited in claim 3, wherein:
the accessory further comprises a housing,
the housing includes a through-bore, and
the cam is arranged at least partially in the through-bore.

5. The assembly as recited in claim 4, wherein the fixture is rotatably mounted to the housing.

6. The assembly as recited in claim 4, wherein:
a pin projects from an opposite side of the housing as the fixture,
the rail includes at least one hole on an opposite side of the rail as the slot,
the pin is configured to project into the at least one hole.

7. The assembly as recited in claim 4, wherein:
the cam includes a first dimension and a second dimension greater than the first dimension,
when the accessory is in the unlocked position, the first dimension is oriented substantially parallel to a central axis of the through-bore;
when the accessory is in the locked position, the second dimension is oriented substantially parallel to the central axis of the through-bore.

8. The assembly as recited in claim 7, wherein:
the rail includes a first surface defining the cavity,
the rail includes a second surface defining the cavity on an opposite side of the cavity as the first surface, and
when the accessory is in the locked position, the clamp portion of the accessory is configured to directly contact the first and second surfaces of the rail.

9. The assembly as recited in claim 8, wherein, when the accessory is in the locked position, the cam is configured to directly contact the first and second surfaces of the rail.

10. The assembly as recited in claim 8, wherein:
the clamp portion includes a first slider and a second slider moveable within the through-bore in response to movement of the cam, and
when the accessory is in the locked position, the cam is positioned such that the first slider and the second slider are in direct contact with the first and second surfaces of the rail, respectively.

11. The assembly as recited in claim 2, wherein the accessory is configured to hold the fixture in the locked position.

12. The assembly as recited in claim 11, wherein:
the accessory further comprises a housing including a recess,
the fixture is rotatably mounted to the housing,
the recess is formed in a side of the housing facing the fixture,
the accessory further comprises a detent at least partially within the recess,
the detent is moveable within the recess,
the detent is biased toward the fixture, and
the detent includes a slot configured to receive a portion of the fixture when the accessory is in the locked position.

13. The assembly as recited in claim 12, wherein:
the detent includes a first ramped wall leading to an opening of the slot,
the detent includes a second ramped wall leading to an opening of the slot, and
the first and second ramped walls are inclined such that the first and second ramped walls become gradually closer to the housing when moving away from the slot.

14. The assembly as recited in claim 11, wherein:
the accessory further comprises a fastener,
the accessory further comprises a housing,
the fixture and the fastener are rotatably mounted to the housing,
the fixture is attached to a plate including a notch,
the fastener is biased toward the plate and the notch,
a portion of the fastener is configured to be received in the notch when the accessory is in the locked position.

15. The assembly as recited in claim 14, wherein the portion of the fastener is configured to abut the plate when the accessory is in the unlocked position.

16. The assembly as recited in claim 1, wherein the fixture is one of a tie-down, a cleat, a handle, and a portion of a cross-bar.

17. The assembly as recited in claim 1, wherein the fixture includes a portion defining a closed-loop.

18. The assembly as recited in claim 1, wherein the rail extends along a side wall of a cargo area of a motor vehicle.

19. A method, comprising:
inserting an accessory into a slot of a rail such that a clamp portion of the accessory is within a cavity of the rail when the accessory is in an unlocked position; and
following the inserting step, configuring the accessory in a locked position in which the clamp portion is not removable from the cavity via the slot.

20. The method as recited in claim 19, further comprising:
following the step of configuring the accessory in the locked position, configuring the accessory in the unlocked position and removing the clamp portion from the cavity via the slot.
